(19) United States
(12) Patent Application Publication
(10) Pub. No.: US 2018/0101372 A1
(43) Pub. Date: Apr. 12, 2018

(54) SECURE APPLICATION PACKAGING IN THE CLOUD

(71) Applicant: Microsoft Technology Licensing, LLC, Redmond, WA (US)

(72) Inventors: Mariyan D. Fransazov, Kirkland, WA (US); Andrew Michael Pennell, Kirkland, WA (US); Mark David Overholt, Bellevue, WA (US); Madhur Vishwanath Badal, Redmond, WA (US); Rajasekaran Rangarajan, Kirkland, WA (US)

(21) Appl. No.: 15/289,019

(22) Filed: Oct. 7, 2016

(51) Int. Cl. G06F 9/445; G06F 9/45; H04L 29/08

(52) U.S. Cl. CPC G06F 8/61; H04L 67/34; G06F 8/41

(57) ABSTRACT

Compiling a software application on a cloud computer system. An indication is received from a client at a cloud computer system. The indication comprises an indication that an uncompiled created software application is to be compiled. Receiving the indication includes receiving a document from the client, wherein the document comprises source code associated with the uncompiled created software application. The document is created at the client, wherein the client is at a location remote from the cloud computer system. In response to receiving the indication to compile the created software application, the document is compiled at the cloud computer system such that the compiled document is executable as a software application. The compiled document is then sent to the client for use as the software application, and stored in a cloud storage application repository such that sharing of compiled documents associated with executable software applications is possible.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

More recently, individuals and families have begun to acquire numerous computer systems and devices that may be used nearly constantly throughout a given day. For instance, an individual may have a smartphone, a tablet, a laptop, and a desktop, each of which may be used during the individual's daily routine. As such, individuals often share, download, upload, access, and/or transmit various video files, audio files, software applications, social media and so forth with others. Such constant use of transmitted electronic data each day causes a heightened risk of computer viruses infecting these numerous computer systems and devices. Furthermore, the constant sharing of such transmitted electronic data (e.g., video, audio, and so forth) allows viruses to be transmitted quickly, and oftentimes efficiently. As such, ensuring the safety of electronic data to be shared is critically important in the modern world.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to compiling a software application on a cloud computer system. For example, embodiments may include receiving an indication, at a cloud computer system, from a client that an uncompiled created software application is to be compiled. Receiving the indication includes receiving a document from the client, wherein the document comprises source code associated with the uncompiled created software application. The document is created at the client, wherein the client is at a location remote from the cloud computer system. In response to receiving the indication to compile the created software application, the document is compiled at the cloud computer system such that the compiled document is executable as a software application. The compiled document is then sent to the client for use as the software application, and stored in a cloud storage application repository such that sharing of compiled documents associated with executable software applications is possible.

Accordingly, a document acting as source code for an application created at a client computer system may be sent to a cloud service to be compiled. Compilation at the cloud service, rather than at a client computer system, may allow the cloud service to ensure that any document associated with a created application to be compiled is legitimate and secure. Once the legitimacy and security of the document is ensured by the cloud service, the cloud service may then compile the document. The cloud service can then ensure the integrity of the compiled document (i.e., the executable application), as well. The executable application may then be stored in an application repository to allow for viral sharing of the executable application. For instance, once stored in the application repository, an author of the application may share the application with other users, thus allowing those users to utilize the created executable application. In this way, packaging/compiling applications at a cloud service may ensure that any created executable application is trustworthy, and therefore secure with respect to viral sharing of the created executable application.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates operation of the principles described herein.

FIG. 2 illustrates an example environment for packaging a created application at a cloud computer system.

FIG. 3 illustrates a flow chart of an example method for packaging a created application at a cloud computer system.

### DETAILED DESCRIPTION

At least some embodiments described herein relate to compiling a software application on a cloud computer system. For example, embodiments may include receiving an indication, at a cloud computer system, from a client that an uncompiled created software application is to be compiled. Receiving the indication includes receiving a document from the client, wherein the document comprises source code associated with the uncompiled created software application. The document is created at the client, wherein the client is at a location remote from the cloud computer system. In response to receiving the indication to compile the created software application, the document is compiled at the cloud computer system such that the compiled document is executable as a software application. The compiled document is then sent to the client for use as the software application, and stored in a cloud storage application repository such that sharing of compiled documents associated with executable software applications is possible.

Accordingly, a document acting as source code for an application created at a client computer system may be sent to a cloud service to be compiled. Compilation at the cloud service, rather than at a client computer system, may allow the cloud service to ensure that any document associated with a created application to be compiled is legitimate and secure. Once the legitimacy and security of the document is ensured by the cloud service, the cloud service may then compile the document. The cloud service can then ensure the integrity of the compiled document (i.e., the executable application), as well. The executable application may then be stored in an application repository to allow for viral sharing of the executable application. For instance, once stored in the application repository, an author of the application may share the application with other users, thus allowing those users to utilize the created executable application. In this way, packaging/compiling applications at a cloud service may ensure that any created executable application is trustworthy, and therefore secure with respect to viral sharing of the created executable application.

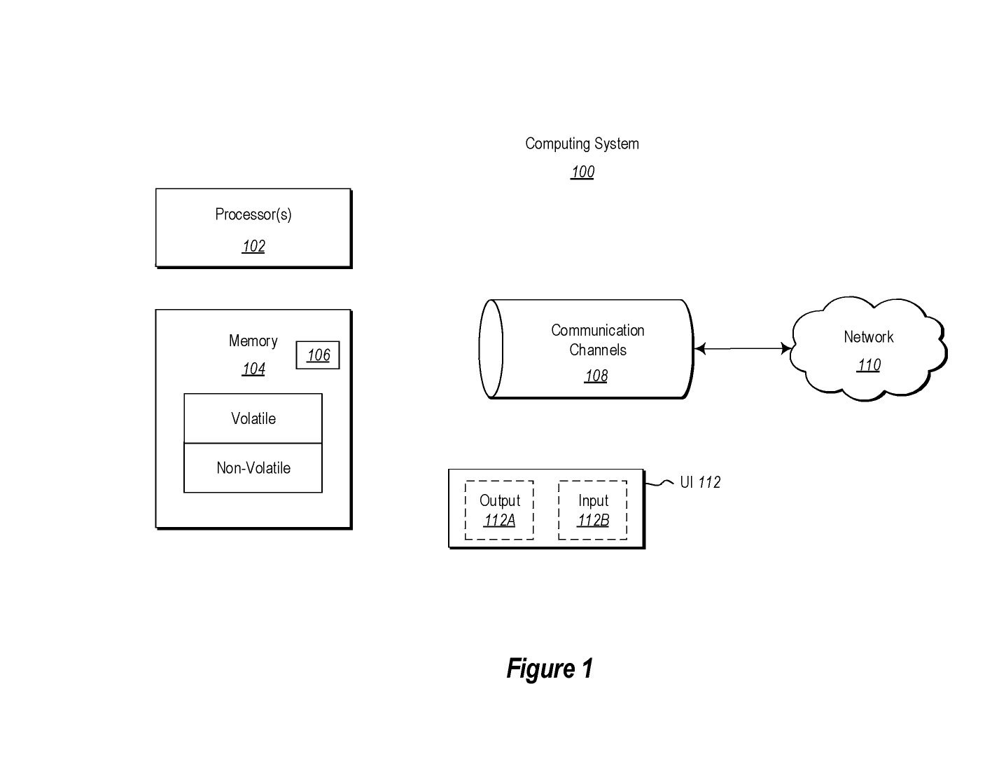

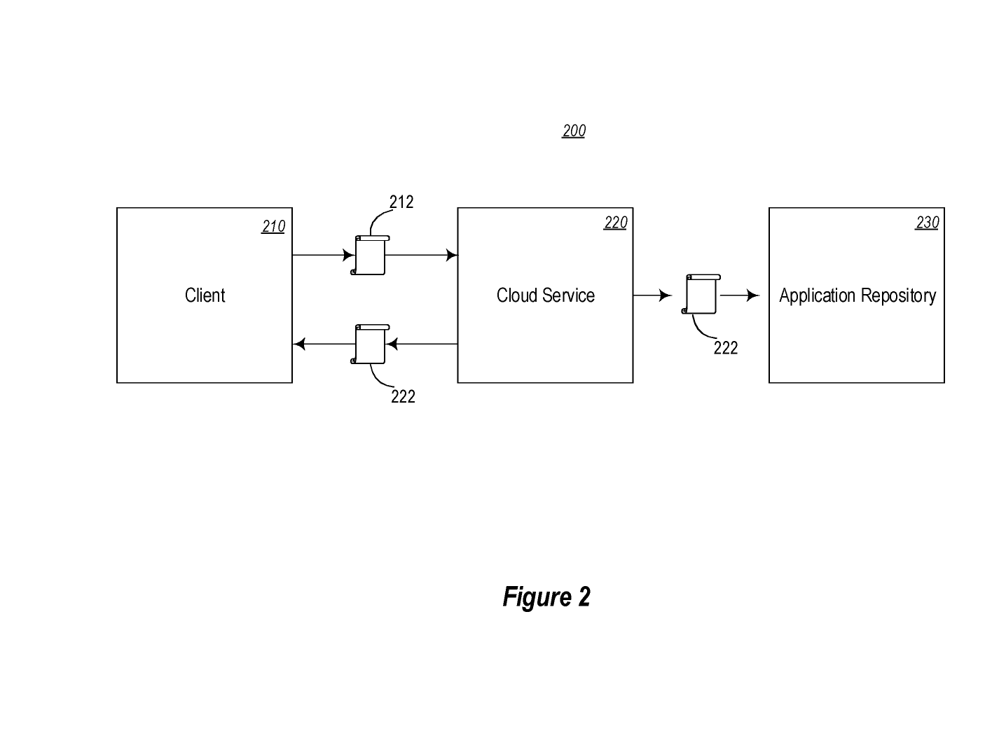

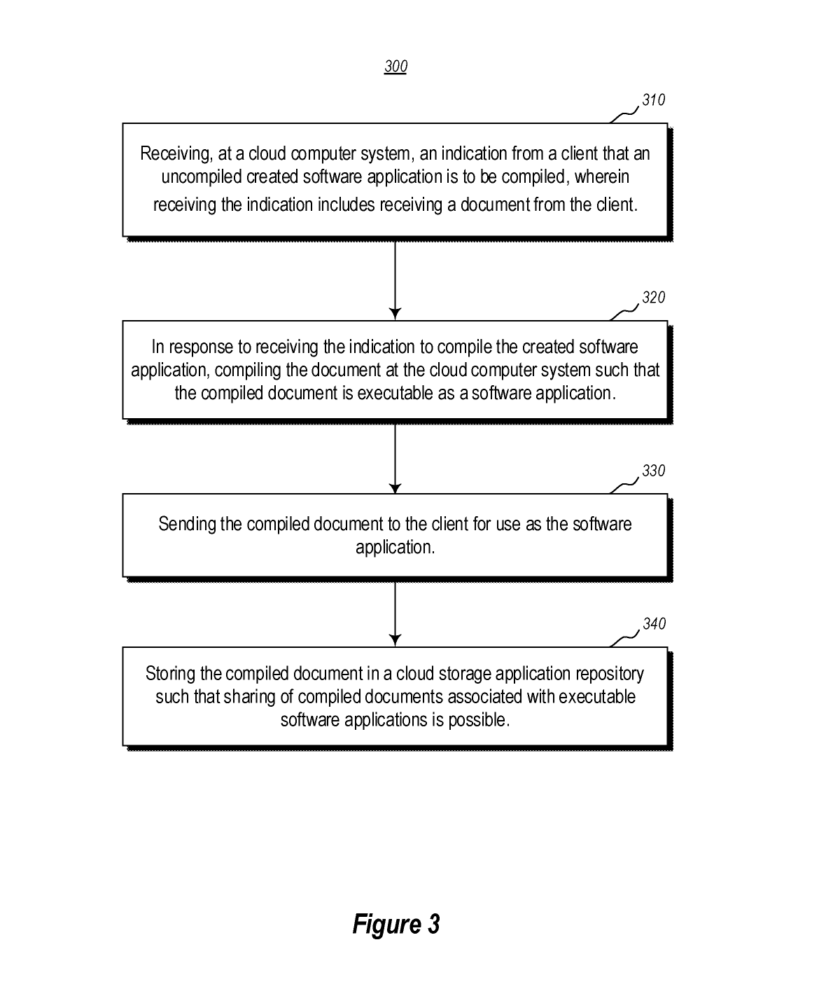

Some introductory discussion of a computing system will be described with respect to FIG. 1. Then packaging applications at a cloud computer service will be described with respect to FIGS. 2 and 3.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “control”, “signature generator”, “key generator” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

FIG. 2 illustrates a computer environment 210 for performing the packaging of an application at a cloud computer service. FIG. 2 includes client computer system 210. Client computer system 210 may comprise any type of computer system, including a mobile device (e.g., a smartphone, a tablet, and so forth), a laptop computer, a desktop computer, and so forth. Furthermore, client computer system 210 may run any operating system, whether currently developed or to be developed in the future, including MICROSOFT® WINDOWS®, APPLE® OS X®, APPLE IOS®, GOOGLE™ CHROME OS™, UBUNTU®, LINUX®, and so forth. Alternatively, client computer system 210 may comprise a website, web service, web application, desktop application, mobile application, and so forth. In yet W other embodiments, the client computer system 210 may be a combination of a computer system (e.g., a laptop computer) running an application (e.g., a desktop application, a website, a web service, a web application, a mobile application, and so forth).

FIG. 2 also includes cloud service 220. Cloud service 220 may be any applicable type of cloud computer system that is remote from the client 210. For example, cloud service 220 may comprise MICROSOFT AZURE®, AMAZON WEB SERVICES®, and so forth. As shown, FIG. 2 also includes application repository 230, which may be capable of storing any application created at client computer system 210. Additionally, application repository 230 may allow for viral sharing of any application stored within the application repository, as further described herein. While application repository 230 is shown in FIG. 2 as being separate from cloud service 220, application repository 230 may instead be included within cloud service 220.

FIG. 2 also includes document 212 and packaged/compiled executable application 222. Executable application 222 is a compiled and executable version of the document 212, as described more fully herein. Document 212 may be a non-executable declarative document that functions as source code for a created application. As such, document 212 may include one or more declarative expressions that comprise easy-to-use programming languages and expressions (i.e., declarative language). For instance, such declarative expressions may be similar to the expressions used in MICROSOFT EXCEL®. Additionally, the document 212 may have an underlying transformation chain. A transformation chain is an interconnected set of nodes that each may represent data sources or data targets. There are links between the nodes, each link representing a transformation.

For instance, a transformation of the transformation chain may be declaratively defined when creating an application. For any given link, the associated transformation receives copies of values of one or more data sources situated at an input end to the link, and generates resulting values being provided at one or more data targets located at the output end of the link. For any given transformation, when a value at one or more of the data sources at its input end changes, the transformation is automatically reevaluated, potentially resulting in changes in value(s) of one or more data targets at the output end of the transformation.

An input node of a transformation chain may be, for instance, a sensor, a data source, or a UI control that receives input. An output node of a transformation chain may be, for instance, a data target, a visualization, or a UI control that outputs data. In one embodiment, regardless of how complex the transformation chain is, the transformations may be constructed from declarative statements expressing equations, rules, constraints, simulations, or any other transformation type that may receive one or more values as input and provide resulting one or more values as output. Transformation chains may be augmented as a program is built by linking different transformation chains to honor the dependencies between the chains. In some embodiments, such dependencies may be declaratively defined using a function editor when creating an application. As such, as an author builds an application incrementally, the transformation chain that represents the application likewise augments incrementally.

As briefly described, an application may be created at client computer system 210. Once an application has been created at client computer system 210, the application may be packaged by cloud service 220. The cloud service 220 may then store the packaged executable application within application repository 230, which application repository may be included within cloud service 220 or comprise a standalone service.

In a specific example, client 210 may be a computer system running MICRSOFT POWERAPPS™ (POWERAPPS). When a user has created an application, a document 212 associated with the created application (i.e., source code of the application) may be concurrently created. As such, once the user has created the application using POWERAPPS and indicates to the client 210 a desire to use the created application, document 212 may be sent to cloud service 220 for packaging/compilation. In some embodiments, document 212 may be sent to the cloud service 220 to be packaged/compiled when the user attempts to save the application. In other embodiments, document 212 may be sent to the cloud service 220 to be packaged/compiled when the user attempts to publish the created application for use by the user and/or others.

Once the cloud service 220 has received the document 212, the cloud service 220 and/or the application repository 230 may determine whether packaging/compiling has already been performed with respect to the received document. If cloud service 220 and/or the application repository 230 determine that document 212 has already been packaged/compiled, the cloud service 220 and/or the application repository 230 may fetch the packaged/compiled executable application 222, and send the executable application to the client 210. On the other hand, if the cloud service 220 and/or application repository 230 determine that the received document 212 has not been compiled, the cloud service may compile the document 212 to create an executable application 222.

In some embodiments, the document 212 may be compiled to execute in any number of different environments. As such, packaged executable application 222 a may be created such that the single packaged executable application can be executed in any computing environment (e.g., a desktop browser, a mobile application, a desktop application, and so forth). In other embodiments, the document 212 may be compiled to execute only in the environment (e.g., web application, mobile application, desktop application, and so forth) in which a user has requested the executable application 222 is to be executed. For instance, a user may request to publish an application such that the packaged executable application 222 may execute in a desktop browser. In another embodiment, a user may request to package an application to run on a particular desktop browser. In such an instance, a document 212 associated with the created application may be specifically packaged/tailored for execution in the particular desktop browser environment. While the previous example is discussed in regards to a desktop browser, the example may also apply to specific desktop operating systems, mobile operating systems, mobile hardware/devices, desktop hardware/devices, and so forth.

As illustrated in FIG. 2, upon packaging/compilation of document 212 into executable application 222, the executable application 222 may also be sent to application repository 230 for storage. Once the executable application 222 is stored in application repository 222, the user (or owner) of the executable application 222 may share the executable application with others such that those who have been given permission by the user can access the executable application from the application repository 230. Those users who have been given permission by the user may then consume/utilize the created application.

While, packaging an application in the cloud has been described as first sending the document 212 to cloud service 220, the document may first be sent to an application repository 230. The application repository 230 may then send the a document 212 to cloud service 220. In such instances, cloud service 220 may comprise a cloud service specifically created for application packaging. The cloud service may then package/compile the document 212 in order to generate an executable application 222. The cloud service may then send the executable application 222 to the application repository 230, where the executable application can be stored. Finally, the application repository may then send the packaged executable application to the user for consumption, sharing, and so forth of the executable application.

In some embodiments, the executable application 222 may comprise JAVASCRIPT® and/or hypertext markup language (HTML). While the executable application 222 is discussed as including JAVASCRIPT and/or HTML, the executable application may include any one or more suitable computer-executable languages, whether currently developed or to be developed in the future. However, regardless of the language(s) used in the executable application 222, performing the packaging of document 212 at cloud service 220 may improve the security and trustworthiness of the executable application 222. Additionally, saving the executable application 222 in application repository 230 may facilitate viral sharing. For example, once a user has created an application, the application (i.e., the document 212) has been compiled to create an executable application 222, the user may share the executable application 222 with other users. Those other users may then access (e.g., download) the executable application 222 from the application repository 230 for use of the executable application by the other users.

As such, if packaging/compilation were to be performed on client computer system 210, while still storing the resulting executable application(s) in application repository 230, a malicious client may be able to tamper with the executable application (i.e., generated code associated with the executable application) before transmitting it to the application repository 230 for viral sharing. For instance, assume that application repository 230 simply identifies whether any particular received (and already compiled) application is comprised of JAVASCRIPT in order to accept and store the received application. In such an instance, a user could create a malicious JAVASCRIPT file that appears to be an application. In response, the application repository 230 may accept and store the malicious file, which could then be shared with others. Accordingly, sending the document 212 (i.e., the source code of a created application) to cloud service 220 for packaging/compiling (rather than packaging/compiling at the client) may allow the cloud service to ensure that any executable application 222 is a legitimate, secure application before storing the executable application in application repository 230 for viral sharing.

In some embodiments, each time a document 212 associated with a particular created application is packaged/compiled, the resulting packaged executable application 222 may be a unique executable application having a unique version number. A packaged executable application 222 may be assigned a unique version number based on a version of the document 212 that is sent to cloud service 220. In an example, assume a user has created an application and attempted to publish the created application. The packaged executable application resulting from that attempt to publish will be assigned a first unique version number. When the user decides to modify that created application and again attempts to publish, the resulting packaged executable application may be assigned a second unique version number. Accordingly, each time a user changes a created application and attempts to publish the changed application, the resulting packaged executable application may be assigned a unique version number that is different from any other version of the

Alternatively, a packaged executable application 222 may be assigned a unique version number based on which client/user is requesting the packaged executable application. For example, when an author of a created application requests to publish the created application, the resulting packaged executable application may be assigned a first unique version number. When a user who has been authorized by the author to access the created application requests to access the application, a different packaged executable application having a second unique version number may be generated/compiled. In yet other embodiments, both the document version and the particular client/user requesting the packaged executable application may be considered in assigning the resulting executable application a unique version number.

Each version of the packaged executable applications may then be stored and cached by cloud service 220 and/or application repository 230. Accordingly, if a packaged executable application having a version number corresponding to the particular version of the document 212, the particular user making the request, or both (depending on the combination of factors being used) has already been compiled, cloud service 220 and/or application repository 230 may provide that particular packaged executable application. If such a packaged executable application does not exist, cloud service 220 may package/compile the received document 212 and provide the packaged executable application 222 to the user.

In some embodiments, a created application may also include assets, including images, video, audio, and so forth. Such assets may be stored on client computer system 210, within a cloud storage service, or any other type of data storage. Regardless of where assets to be used in a particular created application are stored, such assets may be uploaded to cloud service 220 and/or application repository 230 prior to compilation of the document 212 associated with the particular created application, so that the cloud service 220 has access to the assets during compilation.

FIG. 3 illustrates an example method 300 for packaging/compiling a software application on a cloud computer system. As such, frequent reference will be made to the computing environment 200 of FIG. 2. The method 300 includes receiving, at cloud service 220, an indication from a client 210 that an uncompiled created software application (i.e., document 212) is to be compiled, wherein receiving the indication includes receiving a document from the client (Act 310). Such an indication from the client 210 may comprise an indication that the user has saved the created application, has requested that the created application be published, or has performed any other similar action showing a desire to create an executable application associated with the created application. As described herein, the document may comprise source code associated with the uncompiled created software application (i.e., the document). Additionally, the document may be created at the client computer system 210, which client computer system may be at a remote location with respect to the cloud service 220. For example, a user may have created an application in POWERAPPS and attempted to publish the application for use by the user and/or others.

In response to receiving the indication to compile the created software application, the document may be compiled at the cloud service 220 such that the compiled document is executable as a software application (Act 320). The compiled document (i.e., the executable application 222) may then be sent to the client for use as the software application (Act 330). In the ongoing example, the application created by the user at client 210 using POWERAPPS may be packaged/compiled at cloud service 220 and sent to client 210 for consumption of the application by the user.

The compiled document may then be stored in a cloud storage application repository 230 such that sharing of compiled documents associated with executable software applications is possible (Act 340). In the ongoing example, the user may share the created executable application 222 with other users by giving the other users permission(s) associated with accessing and utilizing the created executable application. Accordingly, once another user has been given permission to access/utilize the created executable application 222, the permitted user may access the executable application via application repository 230.

Accordingly, a declarative document acting as source code for an application created at a client computer system may be sent to a cloud service to be compiled. Compilation at the cloud service, rather than at a client computer system, may allow the cloud service to ensure that any document associated with a created application to be compiled is legitimate and secure. Once the legitimacy and security of the document is ensured by the cloud service, the cloud service may then compile the document. The cloud service can then ensure the integrity of the packaged and compiled document (i.e., the executable application), as well. In other words, the cloud service can ensure that the packaged and compiled document is safe for use and sharing by users. The executable application may then be stored in an application repository to allow for viral sharing of the executable application. For instance, once stored in the application repository, an author of the application may share the application with other users, thus allowing those users to utilize the created executable application. In this way, packaging/compiling applications at a cloud service may ensure that any created executable application is trustworthy, and therefore secure with respect to viral sharing of the created executable application.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A computer system comprising:
one or more processors; and
one or more computer-readable storage media having stored thereon computer-executable instructions that are executable by the one or more processors to cause the computer system to compile a software application on a cloud computer system, the computer-executable instructions including instructions that are executable to cause the computer system to perform at least the following:
at a cloud computer system, receive an indication from a client that an uncompiled created software application is to be compiled, receiving the indication including:
receiving a document from the client, the document comprising source code associated with the uncompiled created software application, wherein the document is created at the client, the client being remote from the cloud computer system;
in response to receiving the indication to compile the created software application, compile the document at the cloud computer system such that the compiled document is executable as a software application;
send the compiled document to the client for use as the software application; and
store the compiled document in a cloud storage application repository such that sharing of compiled documents associated with executable software applications is possible.

2. The computer system in accordance with claim 1, wherein the document comprises a declarative document that includes one or more declarative expressions.

3. The computer system in accordance with claim 1, wherein the document comprises a transformation chain.

4. The computer system in accordance with claim 1, wherein the compiled document is executable as at least one of a web application, a mobile application, and a desktop application.

5. The computer system in accordance with claim 1, wherein the compiled document comprises one or more computer-executable languages including at least one of JavaScript and hypertext markup language.

6. The computer system in accordance with claim 1, wherein the document includes one or more associated assets.

7. The computer system in accordance with claim 6, wherein the one or more assets are uploaded to the cloud computer system prior to compiling the document.

8. The computer system in accordance with claim 1, wherein the received indication comprises an indication that the client desires to publish the uncompiled created software application.

9. A method, implemented at a computer system that includes one or more processors, for compiling a software application on a cloud computer system, comprising:
at a cloud computer system, receiving an indication from a client that an uncompiled created software application is to be compiled, receiving the indication including:
receiving a document from the client, the document comprising source code associated with the uncompiled created software application, wherein the document is created at the client, the client being remote from the cloud computer system;
in response to receiving the indication to compile the created software application, compiling the document at the cloud computer system such that the compiled document is executable as a software application;
sending the compiled document to the client for use as the software application; and
storing the compiled document in a cloud storage application repository such that sharing of compiled documents associated with executable software applications is possible.

10. The method in accordance with claim 9, wherein the document comprises a declarative document that includes one or more declarative expressions.

11. The method in accordance with claim 9, wherein the document comprises a transformation chain.

12. The method in accordance with claim 9, wherein the compiled document is executable as at least one of a web application, a mobile application, and a desktop application.

13. The method in accordance with claim 9, wherein the compiled document comprises one or more computer-executable languages including at least one of JavaScript and hypertext markup language.

14. The method in accordance with claim 9, wherein the document includes one or more associated assets.

15. The method in accordance with claim 14, wherein the one or more assets are uploaded to the cloud computer system prior to compiling the document.

16. The method in accordance with claim 9, wherein the received indication comprises an indication that the client desires to publish the uncompiled created software application.

17. A computer program product comprising one or more hardware storage devices having stored thereon computer-executable instructions that are executable by one or more processors of a computer system to compile a software application on a cloud computer system, the computer-executable instructions including instructions that are executable to cause the computer system to perform at least the following:
at a cloud computer system, receive an indication from a client that an uncompiled created software application is to be compiled, receiving the indication including:
receiving a document from the client, the document comprising source code associated with the uncompiled created software application, wherein the document is created at the client, the client being remote from the cloud computer system;
in response to receiving the indication to compile the created software application, compile the document at the cloud computer system such that the compiled document is executable as a software application;
send the compiled document to the client for use as the software application; and
store the compiled document in a cloud storage application repository such that sharing of compiled documents associated with executable software applications is possible.

18. The computer program product in accordance with claim 17, wherein the document comprises a declarative document that includes one or more declarative expressions.

19. The computer program product in accordance with claim 18, wherein the compiled document is executable as at least one of a web application, a mobile application, and a desktop application.

20. The computer program product in accordance with claim 17, wherein compiling the document at the cloud computer system ensures the safety of the compiled document for use and sharing by users.
